(19) United States
(12) Patent Application Publication
(10) Pub. No.: US 2023/0086843 A1
(43) Pub. Date: Mar. 23, 2023

(54) DISPLAY INTENSITY REDUCTIONS

(71) Applicant: Hewlett-Packard Development Company, L.P., Spring, TX (US)

(72) Inventors: Hsiang Chun Lin, Taipei City (TW); Te-Yueh Lin, Taipei City (TW); Wan Tzu Huang, Taipei City (TW)

(73) Assignee: Hewlett-Packard Development Company, L.P., Spring, TX (US)

(21) Appl. No.: 17/908,930

(22) PCT Filed: Apr. 1, 2020
(86) PCT No.: PCT/US2020/026090

§ 371 Date: Sep. 2, 2022

(51) Int. Cl. G09G 3/20; G06F 3/01; G06F 3/0354

(52) U.S. Cl. CPC G09G 3/20; G06F 3/011; G06F 3/03547; G09G 2320/0626; G09G 2320/0666; G09G 2354/00

(57) ABSTRACT

Examples of computing devices for reducing a blue light intensity of a display device of such computing devices are described herein. In an example, a computing device may include a display device, a sensor, and a processor. The sensor may determine proximity of a user to the display device while the display device is in an ON-state. The processor may compute a time duration of the display device in the ON-state while the user is determined to be in proximity of the display device by the sensor. The processor may further reduce an intensity or illuminance of the display device based on the computed time duration.

### BACKGROUND

Computing devices, such as laptops, smart phones, or tablets may include display devices for display of content.

### BRIEF DESCRIPTION OF FIGURES

The detailed description is provided with reference to the accompanying figures, wherein:

FIG. 1 illustrates a computing device for reducing a blue light intensity of a display device of the computing device, according to an example;

FIG. 2 illustrates a computing device for reducing a blue light illuminance of a display device of the computing device, according to an example;

FIG. 3 illustrates a computing device for reducing a blue light intensity of a display device of the computing device, according to an example;

FIG. 4 illustrates a flow diagram for reducing a blue light intensity of a display device of a computing device, according to an example; and

FIG. 5 illustrates a system environment using a non-transitory computer-readable medium for reducing a blue light intensity of a display device of a computing device, according to an example.

### DETAILED DESCRIPTION

A computing device having a displaying capability includes a display device to display content. Examples of such a display device may include a liquid crystal display (LCD), a light emitting diode (LED) display, or a plasma-based display. In an ON-state and while displaying the content, the display device emits blue light as a component of the displayed content. The blue light is harmful to the eyes of a user viewing the display device. To reduce an intensity of the harmful blue light from the display device, the computing device may include a blue light filter. The blue light filter lowers an amount of the blue light emitted from the display device and protects the user from the possible side effects of the blue light with little or no compromise of colour of the content displayed by the display device.

The blue light filter of the computing device may be switched-on by the user. In an example, the blue light filter of the computing device may be manually switched-on by the user when the user experiences strain in the eyes. When switched-on, the blue light filter operates to filter out the blue light emitted from the display device. The blue light filter may filter out the blue light after a pre-set time period while the display device is in an ON-state. The time period can be pre-set by the user.

Such switching-on of the blue light filter requires an additional action from the user. Further, switching-on the blue light filter after the pre-set time period irrespective of whether the user is in proximity to the device may be unnecessary and may utilize a processor resource of the computing device that regulates the blue light filter.

The present subject matter describes example computing devices with display devices. In the example computing devices described herein, adequate protection from blue light emitted from the display devices is provided to a user of the computing device without an additional effort from the user

In an example, the computing device includes a display device, such as a display panel, a sensor coupled to the display device, and a processor coupled to the sensor and the display device. The display device, while displaying content in an ON-state, emits blue light, which is harmful to eyes of a user of the display device. Further, when the display device is in an ON-state, the sensor of the computing device may determine a proximity of the user to the display device. The proximity of the user to the display device may be indicative of the user using the computing device while the display device is displaying content. The processor of the computing device may compute a time duration for which the display device s in the ON-state and the user is in proximity to the display device.

In an example, in the ON-state of the display device, the processor of the computing device may compare the determined time duration with a time duration threshold at regular time intervals. The processor may check whether the determined time duration is above the time duration threshold. In response to the determined time duration above the time duration threshold, the processor may reduce intensity of the blue light emitted from the display device. In case, the determined time duration is below or less than the time duration threshold, the processor may keep the intensity of the blue light emitted by the display device unaltered.

When the processor is operating to reduce the intensity of the blue light of the display device, the processor is continuously monitoring proximity of the user to the display device based on information by the sensor of the computing device pertaining to proximity of the user to the display device. In case, the user is away from the display device for an idle time threshold, the processor is to stop reducing the intensity of the blue light emitted from the display device, thus keeping the emitted blue light intensity unchanged.

Accordingly, the computing devices of the present subject matter facilitate in providing adequate protection to eyes of the user from harmful blue light emitted by display devices of the computing devices based on proximity of the users with respect to the display devices and without an additional action or effort from the users. In addition, the computing devices of the present subject matter facilitate an efficient operation of the processor. Since the processor of the computing device operates to reduce the blue light intensity when the user is in proximity to the display device and to maintain the blue light intensity when the user is away from the display device. Thus, utilization of the processor of the computing device is optimized.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

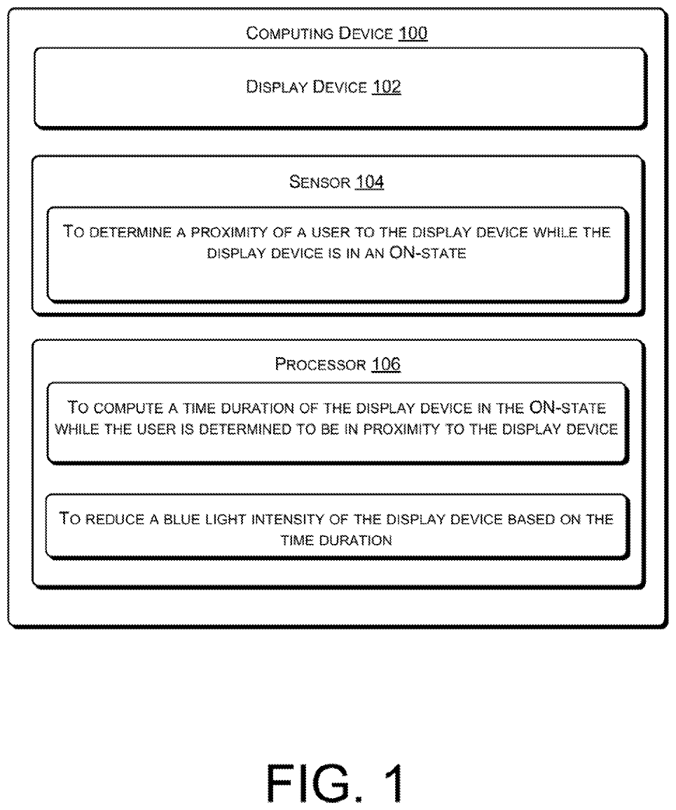

The manner in which the computing devices are implemented are explained in detail with respect to FIGS. 1-5. While aspects of described computing devices can be implemented in any number of different electronic devices, environments, and/or implementations, the examples are described in the context of the following system(s). It is to be noted that drawings of the present subject matter shown here are for illustrative purposes and are not drawn to scale.

FIG. 1 illustrates a computing device 100 for reducing a blue light intensity of a display device 102 of the computing device 100, according to an example. Examples of the computing device 100 may include, but are not limited to, a laptop, a notebook computer, a smart phone, and a tablet. The display device 102 is a panel on to which data is displayed or presented. The display device 102 may be a liquid crystal display (LCD) or a light emitting diode (LED)-based display panel.

The computing device 100 includes a sensor 104 that may determine a proximity of a user to the display device 102 while the display device 102 is in an ON-state. The ON-state of the display device 102 is considered to be a state when the display device 102 is powered and displays or presents content. The sensor 104 may be a proximity sensor, an image capturing device, or a combination thereof, The image capturing device is to reproduce an image of the user in proximity to the display device 102. In an example, the sensor 104 may be any sensor that can determine the proximity of the user to the display device 102. In the ON-state of the display device 102, the display device 102 displays content. While displaying the content, the display device 102 emits a combination of red light, green light, and blue light. When the user is in proximity to the display device and the display device 102 is in the ON-state, the user may operate the computing device 100 while viewing the display device 102. The eyes of the user may be exposed to the light emitted by the display device 102, including the blue light which is harmful for the eyes. For example, the exposure to blue light may cause eye strain or eye damage, such as cataracts and macular degeneration.

The computing device 100 further includes a processor 106 that is coupled to the display device 102 of the computing device 100. The processor 106 is further coupled to the sensor 104 of the computing device 100 so that the proximity of the user to the display device 102 determined by the sensor 104 may be communicated to the processor 106. The processor 106 may handle various tasks of the computing device 100. In an example, the processor 106 may compute a time duration for which the display device 102 is in the ON-state and the user is in proximity to the display device 102.

The processor 106 may compare the time duration with a time duration threshold. In response to determination by the processor 106, based on the comparison, that the computed time duration is above a time duration threshold, the processor 106 may cause a blue light intensity, of the display device 102, to reduce. The reduction of the blue light intensity of the display device 102 is based on the computed time duration. The time duration threshold may be pre-set by the user or a default-set value. In an example, the time duration threshold may be 5 minutes. In such a case, in response to determining by the processor 106 that the user is in proximity to the display device 102 when the display device 102 in the ON-state for more than 5 minutes, the processor 106 operates to reduce the blue light intensity of the display device 102.

The processor 106 of the computing device 100 keeps the intensity of the blue light, emitted by the display device 102, unchanged until determining that the computed time duration is above the time duration threshold. In an example, the processor 106, in response to determining that the computed time duration is less than or equal to the time duration threshold, may keep the intensity of the blue light of the display device 102 unchanged.

The computing device 100 thus facilitates that the reduction of the blue light intensity of the display device 102 is regulated by the processor 106 of the computing device 100 based on the proximity of the user to the display device 102 determined by the sensor 104.

Although, the reduction of the blue light intensity of the display device 102 is explained with respect to the processor 106, the blue light intensity of the display device 102 may be reduced by any other controller or microprocessor of the computing device 100, which is separate from the processor 106 of the computing device 100.

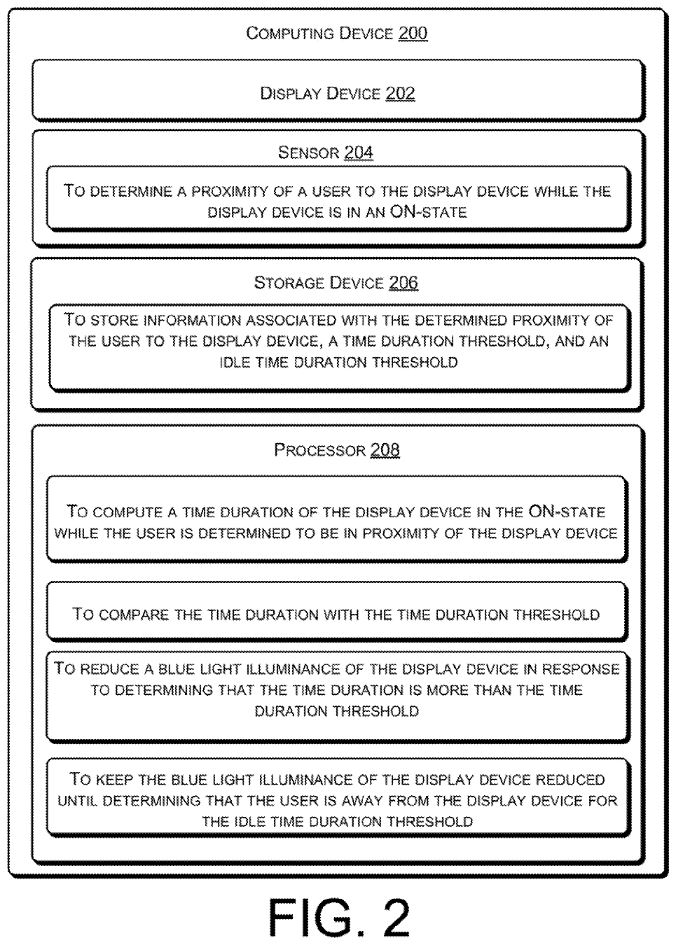

FIG. 2 illustrates a computing device 200 for reducing a blue light illuminance of a display device 202 of the computing device 200, according to an example. In an example, the computing device 200 may be similar to the computing device 100. The display device 202 may be similar to the display device 102. The display device 202, in an ON-state, may display content. The ON-state of the display device 202 is a state in which the display device 202 is powered and operated to display content, such as data.

The computing device 200 includes a sensor 204 coupled to the display device 202. In an example, the sensor 204 may be similar to the sensor 104 and determines a proximity of a user with respect to the display device 202. The proximity of the user is determined by the sensor 204 when the display device 202 is in the ON-state and displaying the content.

Further, the computing device 200 includes a storage device 206. The storage device 206 may be coupled to the display device 202 and the sensor 204. The storage device 206, can include any non-transitory computer-readable medium known in the art including, for example, volatile memory, such as static random-access memory (SRAM) and dynamic random-access memory (DRAM). in an example, the storage device 206 may be a shared memory, such that the storage device 206 may be simultaneously accessible by multiple applications and devices. In an example, the storage device 206 may store information associated with the determined proximity of the user to the display device 202, a time duration threshold, and an idle time threshold. The information associated with the determined proximity of the user to the display device 202 is updated periodically in the storage device 206. In case, the user changes the setting to change the time duration threshold and the idle time threshold, the storage device 206 is updated to store the changed time duration threshold and the changed idle time threshold.

The computing device 200 further includes a processor 208 that may be coupled to the display device 202, the sensor 204 and the storage device 206 of the computing device 200. The processor 208 may include microprocessors, microcomputers, microcontrollers, digital signal processors, central processing units, state machines, logic circuitries, and/or any other devices that manipulate signals and data based on computer-readable instructions, Further, functions of the various elements shown in the figures, including any functional blocks labeled as “processor(s)”, may be provided through the use of dedicated hardware as well as hardware capable of executing computer-readable instructions.

The processor 208 may compute a time duration when the display device 202 is in the ON-state and at the same time, the user is determined by the sensor 204 of the computing device 200 to be in proximity of the display device 202. In an example, the time duration is corresponding to presence of the user in front of the display device 202, which is operating to display the content viewed by the user of the display device 202. In the ON-state of the display device 202, the processor 208 may be operating. Every time when the user comes in the proximity of the display device 202, the processor 208 computes the time duration afresh. The processor 208 may compare the computed time duration with the stored time duration threshold. The comparison of the time duration and the time duration threshold is to decide whether to reduce the blue light emitted by the display device 202 in the ON-state.

Based on the comparison, the processor 208 in response to determining that the time duration is less than the time duration threshold, a blue light illuminance of the display device 202 may be maintained by the processor 208. In an example, the processor 208 in response to determining that the time duration is equal to the time duration threshold, the blue light illuminance of the display device 202 may be maintained by the processor 208. In case the processor 208 determines that the time duration is greater than the time duration threshold, the processor 208 may operate to reduce the blue light illuminance of the display device 202. In an example, based on a specific setting, the processor 208 may operate to reduce the blue light illuminance of the display device 202 in case the processor 208 determines that the time duration is equal to the time duration threshold.

When the processor 208 is operating to reduce the blue light illuminance of the display device 202, the processor 208 is simultaneously monitoring the proximity of the user to the display device 202 based on the information provided by the sensor 204. During the monitoring, when the processor 208 determines that the user is away from the display device 202 for the idle time threshold, the processor 208 may bring back the reduced blue light illuminance of the display device 202 to full blue light illuminance. Thus, the blue light illuminance of the display device 202 is reduced until determining by the processor 208 that the user is away from the display device 202 for the idle time threshold. For example, when the processor 208 determines that the user is away from the display device 202 for 5 minutes, the processor 208 may bring back the reduced blue light illuminance of the display device 202 to full blue light illuminance. The processor 208 of the computing device 200 operates efficiently since the processor 208 enables reduction of the blue light illuminance of the display device 202 when the user is sensed to be near the display device 202.

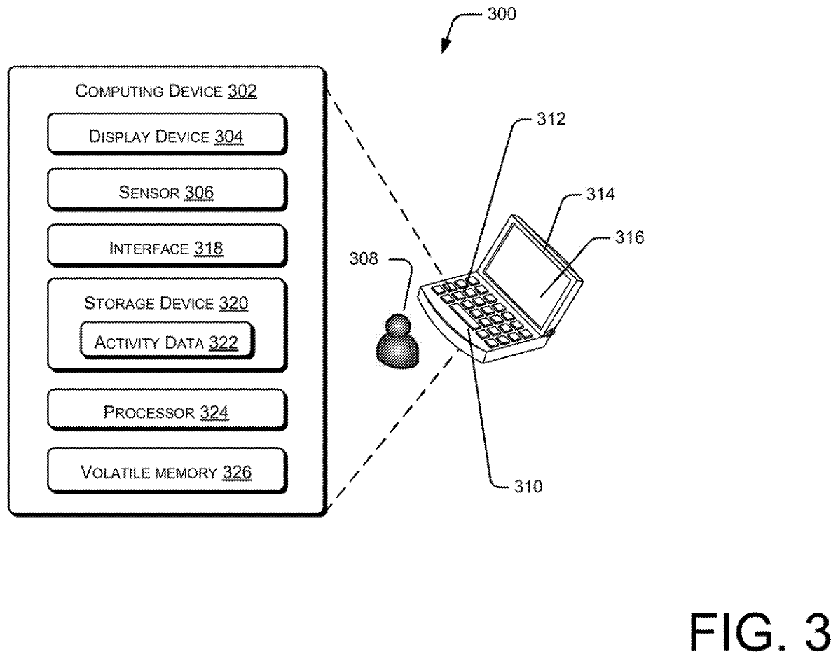

FIG. 3 illustrates a system environment 300 in which a computing device 302 operates for reducing a blue light intensity of a display device 304 of the computing device 302, according to an example. Examples of the computing device 302 having the display device 304 may include, but are not limited to, a laptop, a notebook computer, a smart phone, and a tablet. The computing device 302 may be similar to the computing device 100 and the computing device 200 of FIG. 1 and FIG. 2, respectively.

The computing device 302 includes a sensor 306 coupled to the display device 304. The sensor 306 may sense a presence of a user 308 in front of the display device 304. In an example, the sensor 306 may determine a proximity of the user 308 to the display device 304 when the display device 304 in an ON-state. In an example, more than one sensor 306 may be disposed in the computing device 302 to determine the proximity of the user 308 to the display device 304.

In an example, the sensor 306 may be a proximity sensor or an image capturing device. in an example, the image capturing device may be a webcam. In an example, the image capturing device may capture an image of the user 308 to determine that the user 308 is in proximity to the display device 304. In case the computing device 302 is a laptop, the sensor 306 may be disposed at a C-cover 310 of the computing device 302. The C-cover 310 of the computing device 302 is a bezel that covers a casing of the laptop from a front side having a keyboard 312. When the user 308 presses a key of the keyboard 312 of the computing device 302, the sensor 306 disposed at the C-cover 310 senses the proximity of the user 308 to the display device 304.

In an example, in case the computing device 302 is the laptop, the sensor 306 may be disposed under a touch surface of a touchpad (not shown) of the computing device 302. When the user 308 touches the touch surface of the touchpad to operate the computing device 302, the sensor 306 senses the proximity of the user 308 to the display device 304.

In an example, the sensor 306 may be disposed at a surface 314 of the display device 304 interfacing with a screen 316 of the display device 304. In an example, the image capturing device may be disposed at the surface 314 of the display device 304 interfacing with the screen 316 of the display device 304.

In an example, the display device 304 and the sensor 306 may be coupled to the computing device 302 by means of an interface 318. The interface 318 facilitates the communication of the computing device 302 with the display device 304.

Further, the computing device 302 includes a storage device 320. In an example, the storage device 320 may be a non-volatile memory, such as read only memory (ROM), erasable programmable ROM, flash memories, hard disks, optical disks, and magnetic tapes. The non-volatile memory may store an activity data 322. In an example, the activity data 322 may include information associated with the determined proximity of the user 308 to the display device 304, a time duration threshold, and an idle time threshold. In an example, the information associated with the determined proximity of the user 308 to the display device 304 may change dynamically, while the time duration threshold and the idle time threshold change when the user 308 resets the time duration threshold and the idle time threshold to new values. The information associated with the determined proximity of the user 308 to the display device 304 relates to the presence of the user 308 near the display device 304 when the display device 304 is in the ON-state.

Further, the computing device 302 includes a processor 324. The processor 324 may be similar to the processor 208 of FIG. 2. in an example, the processor 324 may be able to compute a time duration of the display device 304 in the ON-state by accessing the information of the user 308 from the storage device 320, as long as the user 308 is determined to be in proximity of the display device 304.

The processor 324 may compare the computed time duration with the time duration threshold stored in the storage device 320. Further, the processor 324 may operate based on the results obtained by the comparison. In case, in an example, the processor 324 in response to determining, on comparing the computed time duration with the time duration threshold, that the computed time duration is less than or equal to the time duration threshold, the processor 324 of the computing device 302 keeps a blue light intensity of the display device 304 unchanged until determining that h computed time duration exceeds the time duration threshold.

In case, in an example, when the processor 324 determines on comparing the computed time duration with the time duration threshold that the computed time duration is more than the time duration threshold, the processor 324 of the computing device 302 reduces the blue light intensity of the display device 304 for protecting the eyes of the user 308 from harmful blue light emitted from the display device 304.

In an example, the processor 324 of the computing device 302 may reduce the blue light intensity of the display device 304 by a value in a range of 50% to 70%. In an example, reduction of the blue light intensity of the display device 304 may be through a filter that blocks an amount of the blue light with a little or no compromise of other colours of the content displayed by the display device 304.

In case, in an example, when the processor 324 determines that the user 308 is away from the display device 304 for the idle time threshold, the processor 324 may maintain the amount of the blue light emitted from the display device 304, thereby retaining full intensity of the blue light emitted from the display device 304. For example, the processor 324 may cause a system service to run in background to continuously compare the computed time duration with the time duration threshold and to determine an idle time duration, in which the user 308 is away from the display device 304, simultaneously,

In an example, the processor 324 may store the computed time duration and the determined idle time duration in a volatile memory 326 of the computing device 302. in an example, the volatile memory 326 may be separate from the non-volatile memory. The volatile memory 326, communicatively coupled to the processor 324, can include any non-transitory computer-readable medium known in the art including, such as static random-access memory (SRAM) and dynamic random-access memory (DRAM). In an example, the volatile memory 326 may be a shared memory, such that the volatile memory 326 may be simultaneously accessible by multiple applications and devices.

The computing device 302 may also include a graphics controller (not shown) coupled to the processor 324. The graphics controller may include a microprocessor of the computing device 302, which is separate from the processor 324. The graphics controller, when prompted by the processor 324, enables the reduction of the blue light intensity of the display device 304 for protecting the eyes of the user 308 from the intensity of the blue light.

In an example, the user 308 of the computing device 302 may override the processor 324 action that controls the blue light intensity of the display device 304 by, while using applications such as video play, photoshop editing, etc. that require accurate colour performance with colour filtering. Thus, the computing device 302 provides operational flexibility to the user 308 to manually override filtering of the blue light of the display device 304. The computing device 302 also provides flexibility to the user 308 of the display device 304 to pre-set the time duration threshold and the idle time threshold.

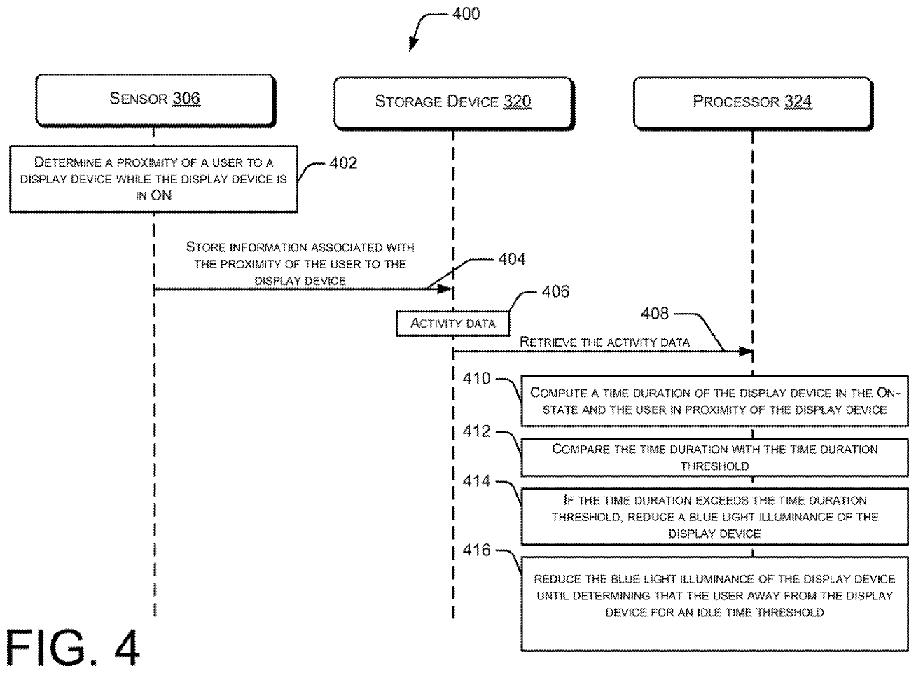

FIG. 4 illustrates a flow diagram 400 for reducing a blue light intensity of the display device 304 of the computing device 302, according to an example of the present subject matter. The various arrow indicators used in the flow diagram 400 depicts the transfer of data between the various entities in the system environment 300, and between the components of the computing device 302 and between the applications running in the computing device 302. The order in which the flow diagram 400 is described is not intended to be construed as a limitation, and any number of the described steps may be combined in any order to implement the flow diagram 400, or an alternative method. Further, certain steps have been omitted in the flow diagram or the sake of brevity and clarity.

Referring to FIG. 4, at step 402, the sensor 306 may perform a real-time determination of a proximity of the user 308 to the display device 304 when the display device 304 is ON. When the display device 304 is referred to as ON, the display device 304 is displaying content to the user 308 of the computing device 302. In an example, the real-time determination of the proximity of the user 308 to the display device 304 may correspond to fact that the user 308 is performing various activities in the computing device 302 while looking at the display device 304.

At step 404, the storage device 320 may store information associated with the proximity of the user 308 to the display device 304 as the activity data 322. Further, the storage device 320 may store a time duration threshold and an idle time threshold as a part of the activity data 322 as shown in step 406. The default values of the time duration threshold and the idle time threshold may be set by the user 308 of the computing device 302. in an example, the time duration threshold and the idle time threshold may be pre-set by the manufacturer of the computing device 302 based on experimental data pertaining to various blue light filtering technologies.

At step 408, the processor 324 may retrieve the activity data stored in the storage device 320. The retrieved activity data may include the information associated with the proximity of the user 308 to the display device 304, the time duration threshold, and the idle time threshold. In an example, the time duration threshold may be in a range of 5 minutes to 10 minutes. In an example, the time duration threshold may be 5 minutes. Further, in an example, the idle time threshold may be in a range of 5 minutes to 10 minutes. In an example, the idle time threshold may be 5 minutes.

At step 410, a time duration may be determined by the processor 324 in a similar manner and similar condition as determined by the processor 106 and the processor 208 of FIG. 1 and FIG. 2, respectively.

At step 412, the processor 324 may compare the determined time duration with the time duration threshold in a similar manner as the processor 208 of FIG. 2 does. As a result of the comparison at step 414, when the determined time duration is found to be more than the time duration threshold, the processor 324 may reduce a blue light illuminance of the display device 304 in a similar manner as done by the processor 208 of FIG. 2.

At step 416, in response to not receiving the information related to the proximity of the user with display device 304 for a time limit which is greater than the idle time threshold, the processor 324 may maintain the blue light illuminance of the display device 304, thereby optimizing the utilization of the processor 324.

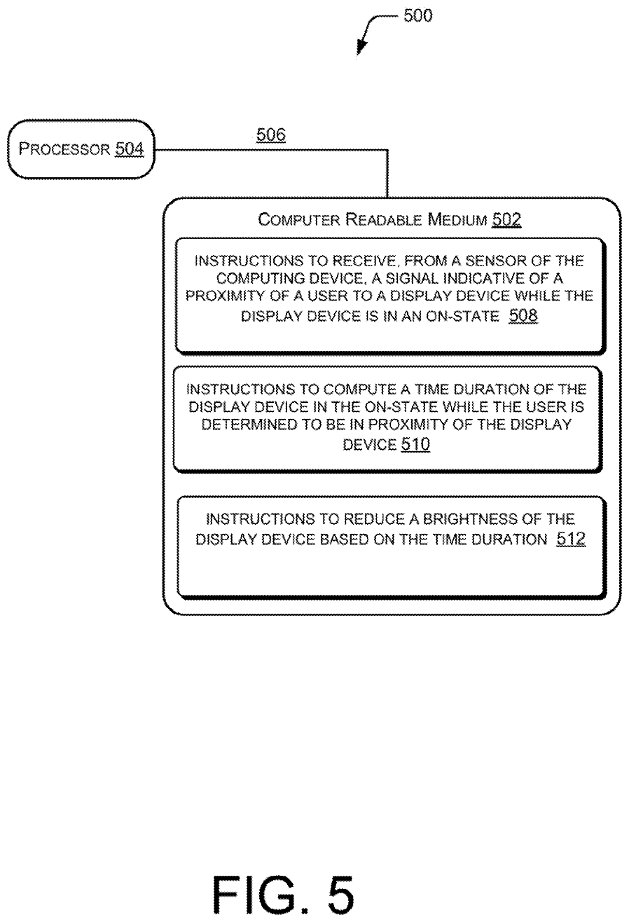

FIG. 5 illustrates a system environment 500 using a non-transitory computer-readable medium 502 for reducing a blue light intensity of a display device of a computing device, according to an example of the present subject matter. The system environment 500 includes a processor 504 communicatively coupled to the non-transitory computer-readable medium 502 through a communication link 506 for fetching and executing computer-readable instructions from the non-transitory computer-readable medium 502.

The non-transitory computer-readable medium 502 may be, for example, an internal memory device or an external memory device. In one example, the communication link 506 may be a direct communication link, such as one formed through a memory read/write interface. In another example, the communication link 506 may be an indirect communication link, such as one formed through a network interface. In such a case, the processor 504 may access the non-transitory computer-readable medium 502 through a network (not shown).

In an example, the non-transitory computer-readable medium 502 includes a set of computer-readable and executable instructions for reducing a blue light intensity of a display device of a computing device. The set of computer-readable instructions may include instructions as explained in conjunction with FIGS. 1 to 3. The set of computer-readable instructions, referred to as instructions hereinafter, may be accessed by the processor 504 through the communication link 506 and subsequently executed to perform acts for reducing the blue light intensity of the display device of the computing device.

Referring to FIG. 5, in an example, the non-transitory computer-readable medium may include instructions 508 that cause the processor 504 to receive a signal indicative of a proximity of a user to a display device, of the computing device, in an ON-state. The signal corresponding to the user's proximity to the display device is received from a sensor, such as the sensor 104 and 204 of the computing device. The ON-state of the display device may be considered when the display device is displaying content.

The non-transitory computer-readable medium 502 may also include instructions 510 to further cause the processor 504 to compute a time duration of the display device in the ON-state. At the same time, during the ON-state of the display device, the user is determined, by the sensor of the computing device, to be in proximity of the display device. The time duration may correspond to a timing when the user is working on the computing device while watching at the display device.

The non-transitory computer-readable medium 502 may include further instructions 512 to cause the processor 504, in response to the computed time duration, to reduce a level of brightness of the display device.

In an example, the reduction in the level of brightness may be understood as the reduction of the intensity of blue light of the display device. By reducing the brightness level of the display device, the eyes of the user of the display device can be protected from possible strain which may otherwise be caused by a brighter display device. In an example, the level of the brightness of the display device can be reduced by a value, but not limited to, in a range of 50% to 70%. In an example, the reduction of the level of the brightness of the display device may be dependent on the technology or the application used for brightness reduction.

The non-transitory computer-readable medium 502 may include further instructions to reduce the level of brightness of the display device by causing the processor 504 to receive information from a storage device of the computing device. The information may include the computed time duration and a time duration threshold, which may be changed based on user's comfort. Further, the instructions may cause the processor 504 to compare the time duration with the time duration threshold and fetch the comparison results. In response to determining by the processor 504 that the time duration exceeds the time duration threshold adjudged as a result of the comparison, the instructions cause the processor 504 to reduce a blue light intensity of the display device for reducing the level of brightness of the display device. In an example, the blue light intensity of the display device may be filtered by 50% to 70% to obtain the level of the brightness of the display device to be reduced in the range of 50% to 70%.

The non-transitory computer-readable medium 502 may include further instructions to cause the processor 504 to maintain the blue light intensity of the display device for keeping the level of brightness of the display from the display device unchanged when the processor 504 determines by the comparison that the time duration is less than or equal to the time duration threshold. The non-transitory computer-readable medium 502 may include further instructions to cause the processor 504 to retain back the level of brightness of the display device to full intensity when the user is determined by the processor 504 to be away from the display device for an idle time threshold.

Although aspects for the present disclosure have been described in a language specific to structural features and/or methods, it is to be understood that the appended claims are not limited to the specific features or methods described herein. Rather, the specific features and methods are disclosed as examples of the present disclosure.

We claim:

1. A computing device comprising:
a display device;
a sensor coupled to the display device to determine a proximity of a user to the display device while the display device is in an ON-state; and
a processor coupled to the display device and the sensor to:
compute a time duration of the display device in the ON-state while the user is determined to be in proximity of the display device; and
reduce a blue light intensity of the display device based on the time duration.

2. The computing device as claimed in claim 1, wherein the processor is to:
compare the time duration with a time duration threshold; and
reduce the blue light intensity of the display device in response to determining, based on the comparison, that the time duration is above the time duration threshold.

3. The computing device as claimed in claim 2, wherein the processor is to keep the blue tight intensity of the display device unchanged in response to determining, based on the comparison, that the time duration is less than or equal to the time duration threshold.

4. The computing device as claimed in claim 1, wherein the sensor is a proximity sensor.

5. The computing device as claimed in claim herein the sensor is an image capturing device.

6. The computing device as claimed in claim 1, wherein the sensor is disposed at a C-cover of the computing device.

7. The computing device as claimed in claim 1, wherein the sensor is disposed under a touch surface of a touchpad of the computing device.

8. A computing device comprising:
a display device;
a sensor coupled to the display device to determine a proximity of a user to the display device while the display device is in an ON-state;
a storage device coupled to the display device and the sensor, wherein the storage device is to store information associated with the determined proximity of the user to the display device, a time duration threshold, and an idle time threshold; and
a processor coupled to the display device, the sensor, and the storage device to:
compute a time duration of the display device in the ON-state while the user is determined to be in proximity of the display device;
compare the time duration with the stored time duration threshold;
reduce a blue light illuminance of the display device in response to determining that the time duration is more than the time duration threshold; and
keep the blue light illuminance of the display device reduced until determining that the user is away from the display device for the idle time threshold.

9. The computing device as claimed in claim 8, wherein the processor is to retain the blue light illuminance of the display device in response to determining that the time duration is less than or equal to the time duration threshold.

10. The computing device as claimed in claim 8, wherein the processor is to retain the blue light illuminance of the display device in response to determining that the user is away from the display device for the idle time threshold.

11. The computing device as claimed in claim 8, wherein the sensor is a proximity sensor, an image capturing device, or a combination thereof.

12. The computing device as claimed in claim 8, wherein the sensor is disposed at a surface of the display device interfacing with a screen of the display device.

13. A non-transitory computer-readable medium comprising computer-readable instructions, which, when executed by a processor of a computing device, cause the processor to:
receive, from a sensor of the computing device, a signal indicative of proximity of a user to a display device of the computing device while the display device is in an ON-state;
compute a time duration of the display device in the ON-state while the user is determined to be in proximity of the display device; and
reduce a level of brightness of the display device based on the time duration.

14. The non-transitory computer-readable medium as claimed in claim 13, wherein, to reduce the level of brightness of the display device, the computer-readable instructions cause the processor to:
compare the time duration with a time duration threshold; and
reduce a blue light intensity of the display device on comparing that the time duration exceeds the time duration threshold.

15. The non-transitory computer-readable medium as claimed in claim 14, wherein the computer-readable instructions cause the processor to maintain the blue light intensity of the display device in response to determining that the time duration is less than or equal to the time duration threshold.
